(19) United States
(12) Patent Application Publication
(10) Pub. No.: US 2024/0001341 A1
(43) Pub. Date: Jan. 4, 2024

(54) Improved water gas shift catalyst

(71) Applicant: TOPSOE A/S, Kgs. Lyngby (DK)

(72) Inventors: Jens SEHESTED, Ballerup (DK); Susanne Lægsgaard JØRGENSEN, Holte (DK); Raul MONTESANO LOPEZ, Kgs. Lyngby (DK); Jeremy Neil BURN, Tølløse (DK); Niels Christian SCHJØDT, Hvalsø (DK)

(73) Assignee: TOPSOE A/S, Kgs. Lyngby (DK)

(21) Appl. No.: 18/250,311

(22) PCT Filed: Nov. 24, 2021
(86) PCT No.: PCT/EP2021/082792

§ 371 Date: Apr. 24, 2023

(30) Foreign Application Priority Data
Nov. 24, 2020 (EP) 20209527.9

(51) Int. Cl. B01J 23/00; B01J 35/10; B01J 35/00; C01B 3/16; B01J 23/80

(52) U.S. Cl. CPC B01J 23/005; B01J 35/1033; B01J 35/0026; C01B 3/16; B01J 23/80; C01B 2203/0283; C01B 2203/1076

(57) ABSTRACT

The present disclosure relates to an improved water gas shift catalyst, in particular an improved high temperature shift catalyst and process using the catalyst. The water gas shift catalyst includes Zn, Al, optionally Cu, and an alkali metal or alkali metal compound, wherein the content of alkali metal, preferably K, is in the range 1-6 wt %, such as 1-5 wt % or 2.5-5 wt % based on the weight of oxidized catalyst, and wherein the water gas shift catalyst has a pore volume, as determined by mercury intrusion, of 240 ml/kg or higher, such as 250 ml/kg or higher. A process for enriching a synthesis gas in hydrogen by contacting the synthesis gas in a water gas shift reactor with the water gas shift catalyst.

### FIELD OF THE INVENTION

The present invention relates to an improved water gas shift catalyst and process using the catalyst.

### BACKGROUND OF THE INVENTION

Water gas shift is a well-known method for increasing the hydrogen content of a synthesis gas, this being a gas produced by e.g. steam reforming of a hydrocarbon feed, and which gas contains hydrogen and carbon monoxide. Water gas shift enables increasing the hydrogen yield and decreasing the carbon monoxide content of the synthesis gas according to the equilibrium reaction: CO+H₂O═CO₂+H₂.

Normally, the hydrogen yield is optimized by conducting the exothermic water gas shift reaction in separate reactors, such as separate adiabatic reactors with inter-stage cooling. Often, the first reactor is a high temperature shift (HTS) reactor having arranged therein a HTS catalyst, and the second reactor is a low temperature shift (LTS) reactor having arranged therein a LTS catalyst. A medium temperature shift (MTS) reactor may also be included or it may be used alone or in combination with a HTS reactor or with a LTS reactor. Typically, HTS reactors are operated in the range 300-550° C. and LTS in the range 180-240° C. The MTS reactor operates normally in the temperature range of 210-330° C.

Within industrial practice, high-temperature shift (HTS) reactors are often started up in a flow of superheated steam which heats up the reactor and the HTS catalyst inside it, which typically is an iron-chromium based catalyst. While the reactor temperature is below the dew point of water, condensation will take place inside the reactor. The use of steam to heat the HTS reactor is particularly often used in ammonia plants of older design. Because of this, normally HTS catalysts containing water soluble compounds have not been used in these plants because of the concern for the leaching of such compounds with subsequent loss of catalytic activity.

Thus, in ammonia plants and hydrogen producing plants, in order to avoid leaching, it is known that the HTS reactor is brought from ambient temperature up to process (operating or reaction) temperature without notable condensation by heating with a gas having a limited content of steam such as dry nitrogen and which is provided by a dedicated separate nitrogen-loop. The nitrogen is inert to the HTS catalyst. However, it would be desirable during starting-up operation, for example due the design of the plant, to avoid the use of such dedicated separate nitrogen-loop and instead being able to heat up to process temperature, i.e. operating temperature of the HTS reactor, by heating the cold reactor and catalyst bed arranged therein by applying steam e.g. superheated steam. Since water is a reactant in the water gas shift reaction, steam is always available in such plants.

High temperature shift catalysts are of two main types. The market predominant established type is iron/chromium (Fe/Cr) based with minor amounts of other components typically including copper. Another type of high temperature shift catalysts is based on a zinc oxide/zinc aluminum spinel structure promoted with one or more alkali elements such as potassium. This type of HTS catalyst usually also contains copper as another promoter. This type of HTS catalyst is described in e.g. applicant's patents U.S. Pat. Nos. 7,998,897 B2, 8,404,156 B2 and 8,119,099 B2. The alkali promoters can be present as water soluble compounds such as salts or hydroxides, e.g. K₂CO₃, KHCO₃ or KOH, in the entire temperature interval of interest for HTS-start up and normal operation, i.e. from −100° C. to 600° C.

Hence, it is generally accepted that when starting up a HTS reactor by using steam, the catalyst is an Fe/Cr based catalyst or a similar catalyst free of species capable of forming water-soluble compounds, such as alkali metals or alkali metal compounds. It has hitherto been considered that only the Fe/Cr based catalysts can tolerate the conditions of condensing steam. Again, the concern has been that the alkali metal or alkali metal compounds used as promoters in the Zn/Al-based catalysts would be leached from the catalyst, thereby losing much of its activity for the HTS reaction.

There is also in fact a consensus in the industry that starting up shift catalysts having water soluble compounds under condensing conditions, particularly in low temperature shift (LTS) reactors and HTS reactors, will lead to the leaching of those compounds and accordingly a degradation of catalytic activity. Thus, EP 3368470 for instance, addresses the problem of soluble species being washed out or redistributed within the catalyst bed during upset conditions that lead to condensation in a LTS reactor. Further, this citation discourages having soluble components being re-deposited in the copper containing catalysts used. Hence, during normal operation, in order to mitigate the impact of poisoning by halogen species present in the feed gas to the LTS reactor, for instance a first shifted synthesis gas from an upstream HTS reactor, it is known to provide dedicated and insoluble guard or sorbent materials upstream a first water gas shift reactor, in particular a HTS reactor, or in between the HTS reactor and a subsequent LTS reactor, in order to capture the halogen species, e.g. chloride species.

Moreover, the use of alkali metal or alkali metal compounds in the LTS catalyst during normal operation of LTS reactors is desirable, because they reduce undesired methanol by-product formation, which is due to the presence of copper in the catalyst and the relatively low operating temperatures of the LTS reactor.

U.S. Pat. No. 6,455,464 discloses a non-chrome, Cu—Al—O catalyst for the hydrogenolysis of carbonyl groups in organic compounds, in which less than 60 wt % of the catalyst has a copper aluminate (CuAl₂O₄) spinel structure and where copper is a leachable compound. Upon activation of the catalyst by reducing gases, CuAl₂O₄ is transformed to metallic copper (Cu) and alumina (Al₂O₃), thus in the active form there is no spinel structure.

Applicant's WO 2017148929 A1 dicloses a revamp method for increasing the front-end capacity of a plant comprising a reforming section and a water gas shift section. In the water gas shift section, the high temperaures shift exchanges the original Fe-based catalyst with a non-Fe based catalyst. The non-Fe based catalyst is the commercial catalyst SK-501 Flex™ having a Zn/Al molar ratio in the range 0.5 to 1.0, a content of alkali metal in the range 0.4 to 8.0 wt % and a copper content in the range 0-10% based on the weight of oxidized catalyst. The pore volume of this catalyst is about 230 ml/kg.

Applicant's US 2011101277 A1 discloses a chromium-free water gas shift catalyst (C8, Example 1) comprising zinc alumina spinel and ZnO, 1.73 wt % K and 1.83 wt % Cu, as well as a Zn/Al molar ratio of 0.57. The density of the pelletized cylindrical tables is 1.80 g/cm³.

### SUMMARY OF THE INVENTION

It is therefore an object of the present invention to provide a novel water gas shift catalyst containing an alkali metal or alkali metal compound which can be subjected to an industrial start-up under steam condensing conditions.

It is another object of the present invention to provide a novel water gas shift catalyst which is resistant to poisoning by halogen species present in the feed gas to a water gas shift reactor having said catalyst arranged therein.

It is another object of the present invention to provide a novel water gas shift catalyst which obviates the use of a dedicated guard or sorbent materials for removal of halogen species in the feed gas.

It is yet another object of the present invention to provide a novel water gas shift catalyst, which is capable of maintaining a high mechanical strength and which is at the same time also capable of being used in a higher number of start-ups compared to known water gas shift catalysts, without losing significant catalytic activity.

It is yet another object of the present invention to provide a simple water gas shift process for removing halogen species present in the feed gas.

It is a further object of the present invention to provide a superior water gas shift process, particularly a HTS process.

These and other objects are solved by the present invention.

Accordingly, in a first aspect, the invention is a water gas shift catalyst comprising Zn, Al, optionally Cu, and an alkali metal or alkali metal compound, wherein the water gas shift catalyst is a Zn/Al-based catalyst, in particular a HTS catalyst, comprising in its active form a mixture of zinc aluminum spinel and optionally zinc oxide in combination with an alkali metal selected from K, Rb, Cs, Na, Li and mixtures thereof, in which the Zn/Al molar ratio is in the range 0.3-1.5 and the content of alkali metal, preferably K, is in the range 1-6 wt %, such as 1-5 wt % or 2.5-5 wt % based on the weight of oxidized catalyst, and wherein the water gas shift catalyst has a pore volume, as determined by mercury intrusion, of 240 ml/kg or higher, such as 250 ml/kg or higher

This enables the provision of a surprisingly robust water gas shift catalyst, suitably a HTS catalyst, with significant mechanical strength and no substantial, if any, loss of catalytic activity.

It would be understood, that the above general embodiment includes Zn, Al; or apart from Zn and Al, also Cu and other elements may be included. In both instances, the rest of the limitations of the embodiment are included, such as having an alkali metal or alkali metal compound, etc.

In an embodiment, the water gas shift catalyst has a pore volume, as determined by mercury intrusion, of 240-380 ml/kg or 250-380 ml/kg or 300-600 ml/kg or 300-500 ml/kg, for instance 250, 300, 350, 400, 450 or 500 ml/kg, or within the range 320-430 ml/kg.

The mercury intrusion is conducted according to ASTM D4284.

By using a water gas shift catalyst with the above pore volumes, the amount of condensing water used to heat the catalyst to the dew point, or any liquid water formed during normal operation, will be less than the total catalyst pore volume. The condensed water, possibly containing dissolved alkali or alkali metal compounds, will thus be retained within the catalyst pores. When the temperature upon continued heating rises above the dew point, the water contained in the catalyst pores will evaporate, leaving alkali metal compounds on the catalyst surface. Thereby, the main part of the catalyst will not lose activity to any significant degree, for instance by virtue of the alkali metal or alkali metal compound no longer being present and thus acting as a promotor, or by virtue of the alkali metal or alkali metal compound no longer being present and thus no longer being capable of reducing any poisoning by the presence of halogens, or by virtue of alkali metal or alkali metal compound no longer being present to reduce the methanol by-product formation in e.g. low temperature shift reactors.

The pore volume, in particular the higher pore volumes, is achieved by providing a water gas shift catalyst particle having a density of for instance 1.4 or 1.5 or 1.6 or 1.7 g/cm³ The lower the particle density the higher the pore volume. The term “particle” means a pellet, extrudate, or tablet, which e.g. have been compactified e.g. by pelletizing or tableting from a starting catalyst material, for instance from a powder into said tablet. Accordingly, in an embodiment according to the first aspect of the invention, the catalyst is in the form of a pellet, extrudate or tablet, and the density is 1.25-1.75 g/cm³, or 1.55-1.85 g/cm³, for instance 1.3-1.8 g/cm³, or for instance 1.4, 1.5, 1.6, 1.7 g/cm³. The density is measured by simply dividing the weight of e.g. the tablet by its geometrical volume.

Normally, the density of the catalyst particles, for instance a HTS catalyst such as in applicant's U.S. Pat. Nos. 7,998,897 or 8,404,156 is close to 2 g/cm³, for instance up to 2.5 g/cm³ or about 1.8 or 1.9 g/cm³. These relatively high densities contribute significantly to the mechanical strength of the particles, e.g. tablets, so that these can withstand the impact when for instance loading the HTS reactor from a significant height, for instance 5 m. Thus, having a high particle density, for instance 1.8 g/cm³ or higher, is normally desired. By the present invention, it has also been found that by compactifying e.g. tableting to a less dense shape, the pore volume of the particles is increased thereby solving the leaching problems addressed above, yet at the same time the particles maintain a mechanical strength which is adequate for resisting impact upon loading or during normal operation, as well as avoiding increased pressure drop over the reactor during normal operation (continuous operation) due to particles being crushed.

In a particular embodiment the invention is a water gas shift catalyst which comprises only, i.e. consists of:

Zn, Al, optionally Cu, and an alkali metal or alkali metal compound, wherein the water gas shift catalyst is a Zn/Al-based catalyst, in particular a HTS catalyst, comprising in its active form a mixture of zinc aluminum spinel and optionally zinc oxide in combination with an alkali metal selected from K, Rb, Cs, Na, Li and mixtures thereof, in which the Zn/Al molar ratio is in the range 0.3-1.5 and the content of alkali metal, preferably K, is in the range 1-6 wt %, such as 1-5 wt % or 2.5-5 wt % based on the weight of oxidized catalyst, and wherein the water gas shift catalyst has a pore volume, as determined by mercury intrusion, of 240 ml/kg or higher, such as 250 ml/kg or higher.

It would therefore be understood, that this particular embodiment includes Zn, Al; or this particular embodiment includes apart from Zn and Al, also.Cu. In both instances, the rest of the limitations of the embodiment are included, such as having an alkali metal or alkali metal compound, etc.

In an embodiment according to the first aspect of the invention, the Zn/Al molar ratio is in the range 0.5-1.0, for instance 0.6 or 0.7.

By the invention, the content of the alkali metal, preferably K, is in the range 1-6 wt %, such as 1-5 wt % or 2.5-5 wt %. It has been found that in this particular range, the catalytic activity is fairly constant independent on the amount of alkali metal compound being present. By applying this particular range, the catalyst acts like an “alkali-buffer” and thereby the catalytic activity is not impaired significantly if a slight loss of the alkali metal promoter should occur in a part of the reactor, thereby also further increasing the number of start-ups without the catalyst losing activity. Further, by operating with a catalyst having the upper range of the alkali metal, for instance 6 wt % K, leaching of K will in fact bring the activity to a higher level, as it will also become apparent from Example 3 farther below and corresponding FIG. 4. This alkali-buffer effect, or simply buffer effect, takes place since e.g. during start up of a HTS reactor, leaching of say 10% (relative) of the potassium, would decrease the K content from, say 4 wt % K, to 3.6 wt % K, which will not decrease the catalyst activity. In fact, if the initial K content is for instance 6 wt % K or lower, suitably 5 wt % K, the activity would—on a 10% (relative) leaching—increase, since a catalyst with 4.5 wt % K has higher activity than a catalyst with 5 wt % K. The buffer effect is for instance highly beneficial near the reactor wall, where more steam is necessary to heat up due to the high heat capacity of the reactor wall, so that there is a higher risk of alkali leaching. Yet, any alkali leaching after a number of start ups is still not significantly impairing catalytic activity, or even the catalytic activity may increase.

Moreover, if leaching of the alkali occurs during normal operation of the reactor (continuous operation), the buffer-effect will result in the catalytic activity not being impaired.

While events causing leaching of the alkali in the entire catalyst bed may be rare, the buffer effect provides an extra safety for a well operating catalyst bed and thus a well operating water gas shift process, in particular a well operating HTS process.

In an embodiment according to the first aspect of the invention, Cu is in the range 0.1-10 wt %, such as 1-5 wt %, based on the weight of oxidized catalyst. Cu serves as an optional promoter which can be incorporated into the catalyst by conventional impregnation or co-precipitation methods.

By the invention, the alkali metal or alkali metal compounds are leachable. In other words, the alkali metal or alkali metal compounds are species capable of forming a water-soluble compound during operation of the catalyst, for instance during normal operation or during transient operation such as during start-up using steam.

In an embodiment according to the first aspect of the invention, the water gas shift catalyst is free of chromium (Cr). In another embodiment, the water gas shift catalyst is free of iron (Fe). Accordingly, in an embodiment said water gas shift catalyst is free of chromium (Cr) and iron (Fe). A more sustainable and environmentally friendly catalyst is thereby provided, as it is free of Cr. Furthermore, by being free of Fe, undesired formation of hydrocarbons such as methane, is significantly reduced or even eliminated.

As used herein, the term “free of chromium (Cr) and free of iron (Fe)” means that the content of Fe is less than 0.05 wt % or the content of Cr is less than 0.02 wt %. For example, the content of Fe and Cr is not detectable.

It has been found, that under normal operation where there is a need to run the water gas shift reactor, for instance a LTS reactor, at conditions close to the dew point, or even during transient conditions, such as upset conditions or start-up conditions, and which may lead to condensation, the washing out (leaching) of alkali metals or alkali metal compounds, is drastically reduced.

The starting up of a water gas shift reactor, can be a method comprising the steps of: providing a water gas shift catalyst comprising an alkali metal or alkali metal compound; heating the water gas shift catalyst up to the reaction temperature of the water gas shift reaction under steam condensing conditions by applying steam as a heat transfer medium for the water gas shift catalyst, and where the water gas shift catalyst has a pore volume, as determined by mercury intrusion, larger than the volume of liquid water that forms during the heating.

The term “reaction temperature” of the water gas shift reaction is used interchangeably with the term “operating temperature” and “process temperature”. For instance, for high temperature shift, the reaction temperature is within the range 300-550° C.

The term “under steam condensing conditions” means heating at temperatures where liquid water is formed, i.e. up to the dew point of water; for instance, about 12 atm abs with a dew point (Tₛₐₜ) of about 190° C. The term “under steam condensing conditions” may also be understood as cooling a steam containing gas to a temperature below its dew point at the given steam pressure.

As long as the amount of liquid water that forms during heating, i.e. condensed water, is below the pore volume of the catalyst, no transport of the alkali metal or alkali metal compounds between the catalyst particles, e.g. catalyst pellets or catalyst tablets, is taking place. The porosity (pore volume/total particle volume) of the particles determines how much water can be accommodated in the particle without external transport of the water-soluble compound. Even in the case where the amount of water exceeds the pore volume, the loss of the alkali metal or alkali metal compound from the catalyst particles is controlled by diffusion inside the particles and the difference in concentration of the internal solution in the particles and the external concentration. Diffusion in solution is a rather slow process (diffusion coefficient in the order of 10⁻⁶ cm²/s) making the catalyst durable in many start-ups even if excess liquid water is formed in some part of the reactor. An alkali metal or alkali metal compound content above the minimum required for optimal activity is also increasing the industrial longevity of the catalyst, as described in a specific embodiment farther above and illustrated in Example 3 and corresponding FIG. 4.

In an embodiment, the catalyst is in the form of pellets, extrudates or tablets, and the mechanical strength is in the range ACS: 30-750 kp/cm², such as 130-700 kp/cm² or 30-350 kp/cm² ACS is an abbreviation for Axial Crush Strength. Alternatively, the mechanical strength measured as SCS is in the range 4-100 such as 20-90 kp/cm or −40 kp/cm. SCS is an abbreviation for Side Crush Strength, also known as Radial Crush Strength. For a given tablet density, the mechanical strength can vary considerably depending on the machinery used for compactifying the catalyst powder. The lower ranges of mechanical strength (ACS or SCS), for instance up to ACS: 300 or 350 kp/cm² or up to SCS: 40 kp/cm, correspond to those obtained with a small (around 100 g/h) hand-fed tablet machine, a so-called Manesty machine. The upper ranges of mechanical strength, for instance up to ACS: 750 kp/cm² or up to SCS: 90 kp/cm, correspond to those obtained using an automated full-scale device (100 kg/h) such as a Kilian RX machine with rotary press. It would thus be understood, that the tablets obtainable with the Manesty machine have a lower mechanical strength than those obtainable with the Kilian RX machine with rotary press. ACS and SCS are measured in the oxidized form of the catalyst. Further, the mechanical strength is measured according to, i.e. in compliance with, ASTM D4179-11.

The resulting water gas shift catalyst is also superior to prior art catalysts such as applicant's U.S. Pat. No. 7,998,897, as for instance evidenced by the number of start-up runs without the catalyst losing catalytic activity. While a HTS catalyst in accordance with U.S. Pat. No. 7,998,897 could provide 50 start-ups using steam without substantial leaching, the catalyst of the present invention enables providing over 100 start-ups with no noteworthy loss of catalytic activity due to leaching.

It would be understood, that the number of start-ups of e.g. a HTS reactor required during a year may be significant, for instance 5 start-ups per year. Thus, a dedicated nitrogen loop which is normally erected and used for providing a gas having a limited content of steam such as dry nitrogen, for thereby conducting the start-up, is no longer necessary. Again, the invention enables using steam, e.g. superheated steam, which is readily available and integrated in the plant, such as a hydrogen or ammonia producing plant, thereby also simplifying plant operation and reducing capital expenses in the plant. The catalyst of the present invention significantly increases the number of start-ups to be conducted before needing to replace the catalyst.

In an embodiment according to the first aspect of the invention, the alkali metal compound is selected from K, Rb, Cs, Na, Li and mixtures thereof. Preferably, the alkali metal compound is K. Potassium (K) inhibits the formation of undesired methanol as a potential by-product in a LTS reactor, due to the use in the water gas shift catalysts of a catalytic active element such as copper which is known to catalyze methanol production at the low operating temperatures of low temperature shift reactors, such temperatures being normally in the range 180-240° C. Potassium enables also increasing (promoting) the activity of a catalyst of the Zn/Al-type for use in a high temperature shift reactor, normally operating at temperatures in the range of for instance 300-550° C.

Further, an alkali metal or alkali metal compound serves to improve the catalyst resistance to halogen poisoning during normal operation, such as the poisoning by chlorides present in the feed gas, for instance in a synthesis gas or in a first shifted synthesis gas from a HTS reactor, which is then subsequently shifted in a MTS or LTS reactor. In addition, when for instance operating with a HTS reactor followed by a LTS reactor, an alkali metal or alkali metal compound in a HTS catalyst reacts or absorbs the halogens, e.g. chloride, thereby protecting the subsequent LTS catalyst.

As used herein, the term “alkali metal or alkali metal compounds” means respectively an alkali in its elemental i.e. metallic form, such as K, or a compound thereof, such as K₂CO₃, KHCO₃, KOH, KCH₃CO₂ or KNO₃. It would be understood that the water gas shift catalyst in its oxidized state will not contain an alkali metal in its metallic form. Thus, a term such as “the catalyst is promoted by alkali metals” or “alkali promoted catalyst” or similar, means that the catalyst is promoted with an alkali metal compound, which covers all possible compounds of said alkali metal, which can be used as promoter.

Also, for the purposes of the present application, when the term “alkali” is used, it means alkali metal or alkali metal compound.

In an embodiment according to the first aspect of the invention, the heating up to the reaction temperature is conducted in the temperature range −100 C-600° C., such as in the range 0-500° C. The initial (cold) temperature is for instance 0, 2 or 50° C. Suitably also, the water gas shift catalyst is heated up to the the reaction temperature of the water gas shift reaction by means of steam only.

Advantages of the invention include:
The provision of a superior water gas shift catalyst, in particular a HTS catalyst, and thereby superior water gas shift process, in which the catalyst i.a. shows an alkali-buffer effect so that even when some alkali is leached or lost during the water gas shift operation, this being start-up or normal operation, the catalytic activity is maintained or even increased.
The invention teaches how alkali containing water gas shift catalysts, such as alkali-promoted Zn/Al type HTS catalyst, with sufficient pore volumes and a sufficient content of alkali metal or alkali metal compounds, can be heated in condensing steam under start-ups, with a leaching of alkali metal compounds that is so small that it will be inconsequential to the expected industrial lifetime of the catalyst.

In other words, the invention makes it possible to heat to the operating temperature (reaction temperature) under condensing conditions even with alkali-containing catalyst without significant loss of catalytic activity or loss of resistance to halogen poisoning due to leaching.
More specifically for a HTS reactor, when comparing the two types of HTS catalysts, the older Fe/Cr-based catalysts and the newer alkali-containing Zn/Al-based catalyst, the latter type has several advantages. Importantly, it is free of chromium, which is an environmental and health hazard. Hence, a more sustainable approach is hereby provided. Furthermore, the alkali-containing Zn/Al-based catalysts are much more selective since their tendency to produce hydrocarbons like methane from synthesis gas is much less pronounced than is the case for the Fe/Cr-based catalysts. This difference is most apparent when the HTS reactor is operated at low steam/carbon molar ratio in the feed gas e.g. synthesis gas entering the reactor. Low steam/carbon molar ratio conveys the benefit of less steam being used in the process/plant such as a plant for producing e.g. hydrogen or ammonia thereby significantly reducing equipment size in the plant as well as saving energy with attendant reduction in carbon dioxide emissions.
It is also well known that iron containing catalysts need to operate above a certain steam/carbon-molar ratio in the synthesis gas entering a HTS reactor or above a certain oxygen/carbon molar ratio, in order to prevent formation of iron carbides and/or elemental iron, which may lead to severe loss of mechanical strength and accordingly to increased pressure drop over the reactor. The alkali-containing Zn/Al-based catalysts are not sensitive to the steam/carbon molar ratio and do not lose mechanical strength as a result of a low steam content in the feed gas (synthesis gas) to the HTS reactor during normal operation.
The number of start-ups possible is significantly increased whilst still maintaining sufficient mechanical strength in the particles thereby avoiding the penalty of increased pressure drop in the water gas shift reactor.
The ability of copper-containing LTS catalysts to resist poisoning by halogen species such as chloride species e.g. hydrogen chloride is improved by being able to keep the alkali metal or alkali metal compound in the catalyst.

A second aspect of the invention encompasses a process for enriching a synthesis gas in hydrogen by contacting said synthesis gas in a water gas shift reactor with a water gas shift catalyst according to any of the above embodiments according to the first aspect of the invention.

The benefits associated with the water gas shift catalyst, as recited in connection with the first aspect of the invention, enable also a superior water gas shift process.

In an embodiment according to the second aspect of the invention, the water gas shift reactor is a low temperature shift (LTS) reactor, a medium temperature shift (MTS) reactor, or a high temperature shift (HTS) reactor. In a particular embodiment, the process comprises combining a HTS reactor with a LTS reactor, wherein a first shifted gas formed in the HTS reactor is subsequently passed to the LTS reactor.

The water gas shift reactor, may also serve as a reverse water gas shift reactor, whereby a feed gas rich in hydrogen and carbon dioxide is converted to carbon monoxide and water according to the reverse water gas shift reaction: CO₂+H₂═CO+H₂O.

In an embodiment according to the second aspect of the invention, the water gas shift reactor is a HTS reactor operating at a temperature in the range of 300-550° C., and optionally also at a pressure in the range 2.0-6.5 MPa.

In an embodiment according to the second aspect of the invention, the water gas shift reactor is a LTS reactor operating at a temperature in the range of 180-240° C., and optionally also at a pressure in the range 2.0-6.5 MPa.

In an embodiment according to the second aspect of the invention, the water gas shift reactor is a MTS reactor operating at a temperature in the range of 210-330° C., and optionally also at a pressure in the range 2.0-6.5 MPa.

In a third aspect the invention encompasses a water gas shift catalyst comprising, optionally consisting of, Cu, Zn, Al, and an alkali metal or alkali metal compound, wherein the water gas shift catalyst has a pore volume, as determined by mercury intrusion, of 240 ml/kg or higher, such as 250 ml/kg or higher, as measured by mercury intrusion, and wherein the water gas shift catalyst is a low temperature shift (LTS) catalyst in which the alkali metal is selected from K, Rb, Cs, Na, Li and mixtures thereof. In a particular embodiment, Cu, Zn and Al are present in oxide form, i.e. as e.g. respectively CuO, ZnO and Al₂O₃ or as mixed oxides such as e.g. ZnAl₂O₄. This applies for the oxidized (“as loaded”) catalyst. The active form of the catalyst contains copper in a reduced form, preferably as elemental Cu.

Any of the embodiments of the first aspect of the invention and associated benefits may be used with any of the embodiments of the second aspect and third aspect, and vice versa.

### BRIEF DESCRIPTION OF THE DRAWINGS

FIG. 1 shows the increase in temperature and thereby catalytic activity when feeding gas mixture after a number of start-ups in a HTS reactor, as a function of reactor length, in accordance with Example 1.

FIG. 2 shows the pore volume (PV) and mechanical strength (ACS, SCS) of catalysts according to Example 2.

FIG. 3 shows the conversion of carbon monoxide with a HTS catalyst according to the invention with respect to different alkali metals (promoters), according to Example 3. For comparison, an unpromoted catalyst essentially containing no alkali metal compounds, is included.

FIG. 4 shows the conversion of carbon monoxide with a HTS catalyst according to the invention with respect to the weight of potassium as the alkali metal (promoter) in the catalyst, according to Example 3.

### DETAILED DESCRIPTION

### Example 1

A start-up of a HTS reactor under condensing steam carried out at 11.85 atm abs (i.e. about 12 atm abs) with a dew point of Tₛₐₜ=188° C. (i.e. about 190° C.) is representative of an industrial case. The amount of condensate depends on the mass of steel, i.e. the reactor vessel, and the mass of catalyst contained in the reactor as well as on the initial temperature which is usually between 0° C. and 50° C. Table 1 shows typical volumes of liquid (water) that would form in industrial HTS units of small i.e. internal diameter of about 1 m, and big size i.e. internal diameter of about 5 m. It is apparent that the pore volume of the water gas shift catalyst, which by the invention is for instance in the interval 240-380 ml/kg, 250 -800 ml/kg, is sufficient to contain the total volume of liquid that condenses during the heating process.

TABLE 1

| | | | | | Water | Water | Total |
|---|---|---|---|---|---|---|---|
| Internal | Wall | Bed | Catalyst | Initial | condensed | condensed | condensate per |
| diameter | thickness | length | mass | temperature | at wall | at catalyst | catalyst mass |
| [m] | [m] | [m] | [ton] | [° C.] | [m3] | [m3] | [ml/kg] |
| 5.186 | 0.098 | 3.295 | 67.9 | 50 | 1.52 | 3.27 | 70.6* |
| | | | | 2 | 2.04 | 4.40 | 95.0 |
| 1.189 | 0.023 | 2.965 | 3.2 | 50 | 0.08 | 0.17 | 76.8 |
| | | | | 2 | 0.10 | 0.22 | 101.3 |

*Calculated as (1.52 + 3.27)/(67.9) × 1000

The catalyst pellets or tablets that are in close proximity to the reactor wall are exposed to water that condenses to heat up the reactor vessel and the catalyst mass. This means that there is a region of the catalyst bed, which is confined to the periphery of the reactor, whose entire pore volume is utilized to contain the liquid that condenses at the reactor wall. The width of this region depends on the pore volume of the catalysts, and it was found that close to the reactor wall, the larger pore volume enables taking up the additional water being condensed at the wall.

### Catalyst A

A HTS catalyst of the potassium-promoted Zn/Al-type is the catalyst according to example 1 of applicant's patents U.S. Pat. Nos. 7,998,897 or 8,404,156, and where the powder of ZnAl₂O₄ (spinel) and ZnO includes Cu by co-precipitation with a copper salt. The pore volume, as determined by mercury intrusion measurements, tablet density (as measured by simpy dividing the weight of the tablet by its geometrical volume), and potassium content, as measured by the ICP method, as well as copper content, is as follows: pore volume 229 ml/kg, tablet density 1.8 g/cm³, K content: 1.97 wt %, Cu content: 2.71 wt %, based on weight of oxidized catalyst.

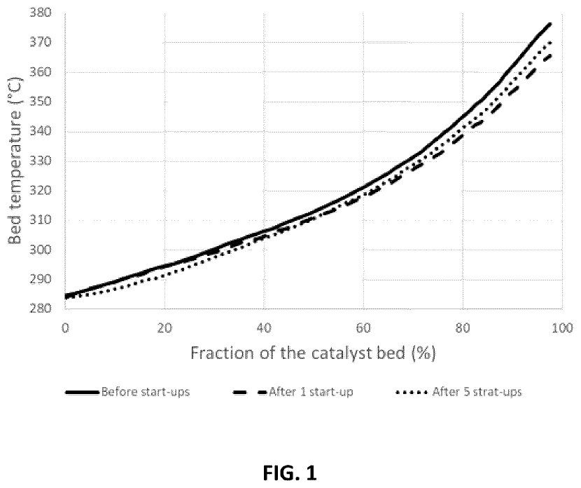

A series of start-ups under condensing steam were carried out in a pilot plant. In the beginning of the tests and after each start-up, the catalyst was exposed to HTS conditions with a gas mixture containing 35 vol % H₂O, 16 vol. % CO, 4 vol. % CO₂, balance H₂, with the reactor operating in (pseudo) adiabatic mode. The increase in the temperature along the reactor length, corresponding to the fraction of the catalyst bed in %, of the accompanying figure, is a direct indication of the catalytic activity. FIG. 1 shows that there is only a marginal loss of activity after the first start-up under condensing steam, and the activity remained unaffected in the subsequent tests.

The pilot studies have also shown that start-up procedures in condensing steam with conditions that replicate those of an industrial condensing start-up provided about 50 start-ups without substantial loss of activity.

### Example 2

### Catalyst B, C

Improved HTS catalysts also of the potassium-promoted Zn/Al-type, in accordance with the present invention were also tested. Accordingly, two catalysts were prepared according to Example 1 of applicant's patents U.S. Pat. Nos. 7,998,897 or 8,404,156, and where the powder of ZnAl₂O₄ (spinel) and ZnO included Cu which was incorporated by co-precipitation of a copper salt. Further, the pore volume of the particles was tailored to 240, 250 ml/kg or higher, for instance in the range 240-380 ml/kg in accordance with the present invention, by compactifying e.g. pelletizing the particles (e.g. tablets) from a powder starting catalyst material, for instance after calcining the catalyst, impregnating it with a solution comprising an alkali compound such as a solution of K₂CO₃, and final mixing with a lubricant such as graphite, as disclosed in Example 1 of the above U.S. Pat. No. 7,998,897 or the above U.S. Pat. No. 8,404,156, yet prior to pelletizing. Thus, instead of compactifying the powder to a catalyst having a density of 1.8 or 2.1 g/cm³ as in example 1 of U.S. Pat. Nos. 7,998,897 or 8,404,156, respectively, the compactifying of the present invention intentionally and surprisingly is conducted to form less dense tablets. The pore volume, as determined by mercury intrusion measurements, tablet density as measured by simply dividing the weight of the tablet by its geometrical volume, and potassium content, as measured by the ICP method, as well as copper content, is as follows:

Catalyst B: pore volume 451 ml/kg, tablet density 1.4 g/cm³, K content: 1.66 wt %, Cu content: 3.81 wt %, based on weight of oxidized catalyst.

Catalyst C: pore volume 320 ml/kg, tablet density 1.7 g/cm³, K content: 3.80 wt %, Cu content: 3.56 wt %, based on weight of oxidized catalyst.

Despite Catalysts B and C being made less dense than Catalyst A, the mechanical strength of the former catalysts is maintained so as not impairing catalyst performance. Catalyst B and C show that start-up procedures in condensing steam with conditions that replicate those of an industrial condensing start-up, result for these catalysts in over 100 start-ups without substantial leaching and thereby without substantial loss of activity.

Additional samples D-1 in below Table 2 were prepared by compactifying in a small, hand-fed tableting machine (so-called Manesty machine) a single batch of powder made according to Example 1 of applicant's U.S. Pat. No. 7,998,897 and with a Zn/Al molar ratio of 0.6. Higher mechanical strengths for the same densities are achievable by conducting the tableting with automated full-scale devices such as a Kilian RX machine with rotary press. For tablet densities of 1.45-1.75 g/cm³, we achieved SCS in the range 50-100 kp/cm and ACS 300-750 kp/cm² using such device, with values of PV in the range 450-300 ml/kg, thus similar to what was obtained for samples made on the Manesty machine with similar tablet densities. ACS and SCS are measured in the oxidized form of the catalyst. Further, the above mechanical strengths are measured in compliance with ASTM D4179-11.

TABLE 2

| | | | | | Mechan- | Mechan- | |
|---|---|---|---|---|---|---|---|
| | | | | | ical | ical | Pore |
| | | | Den- | Den- | strength, | strength, | volume, |
| Tablet | D | H | sity | sity, | SCS | ACS | PV |
| sample | mm | mm | g/cm³ | g/cm³ | kp/cm | kp/cm² | ml/kg |
| D | 5.89 | 3.88 | 1.8 ± | 1.8 | 35 | 319 | 279 |
| | | | 0.05 | | | | |
| E | 5.87 | 3.85 | 1.65 ± | 1.65 | 26 | 217 | 331 |
| | | | 0.05 | | | | |
| F | 5.86 | 3.85 | 1.55 ± | 1.55 | 14 | 133 | 400 |
| | | | 0.05 | | | | |
| G | 5.86 | 5.76 | 1.5 ± | 1.5 | 10 | 101 | 426 |
| | | | 0.05 | | | | |
| H | 5.86 | 3.91 | 1.4 ± | 1.4 | 6 | 57 | 499 |
| | | | 0.05 | | | | |
| I | 5.86 | 3.72 | 1.25 ± | 1.25 | 5 | 39 | 548 |
| | | | 0.05 | | | | |

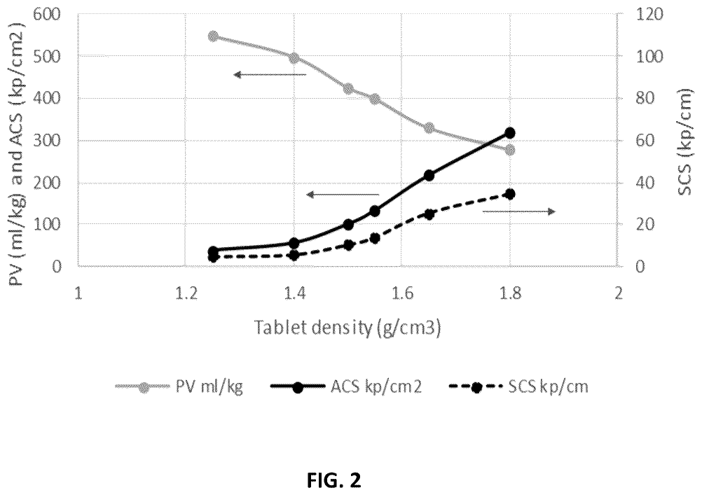

FIG. 2 shows the pore volume (upper curve) and mechanical strength (ACS kp/cm² or SCS kp/cm) of the data of Table 2. FIG. 2 shows clearly, that it is possible to increase the pore volume (PV) by lowering the tablet density and yet still enabling that the mechanical strength is sufficiently high (both ACS and SCS) even for low densities. For instance, even at the lower density of 1.25 g/cm³, the SCS is 5 kp/cm or alternatively ACS is 39 kp/cm², which is sufficient mechanical strength for operation with the high temperature catalyst.

### Example 3

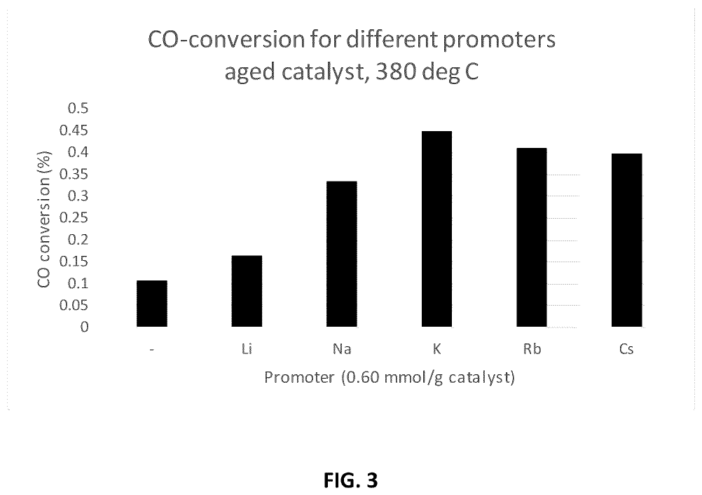

A HTS catalyst of the potassium-promoted Zn/Al-type is the catalyst without copper according to e.g. example 1 of applicant's patents U.S. Pat. No. 7,998,897. FIG. 3 shows the effect of the alkali metals on catalytic activity in terms of CO-conversion at 380° C., in particular the high promoting effect of K, Rb and Cs. The conversion was measured on an aged catalyst. The aging was done by exposing the catalyst to increasing temperature from 330 to 480° C. within a period of 36 hours. For instance, K presents an increase in activity of about 4.5 times with respect to the non-promoted catalyst, while Rb and Cs result in a catalytic activity about 4 times higher with respect to the non-promoted catalyst.

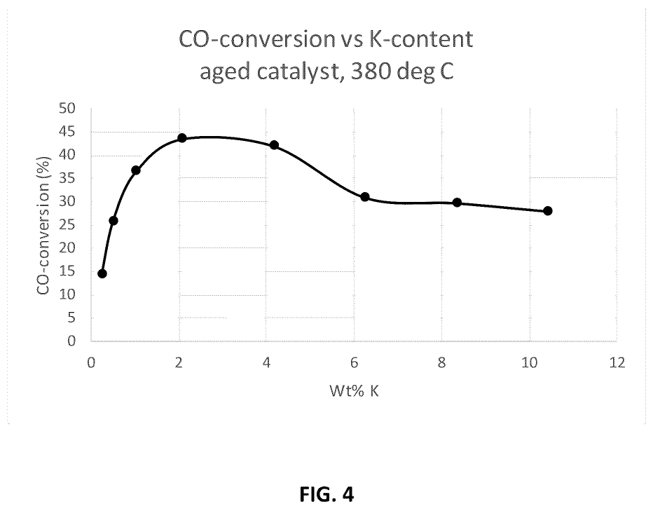

FIG. 4 shows the CO-conversion for potassium as the alkali metal, which surprisingly shows a high promoting effect in particularly the range 1-6 wt % or 1-5 wt %. By operating with a catalyst having more potassium, e.g. about 6 wt %, any leaching of K will actually result in an increase of catalytic activity. If the content of potassium is e.g. 2.5-5 wt %, any leaching of K will still maintain or increase the catalytic activity. The catalyst acts as an “alkali-buffer” and thereby the catalytic activity is not impaired significantly. For instance, leaching of, say 10% (relative) of the potassium, would decrease the K content from, say 4 wt % K, to 3.6 wt % K, which will not decrease the catalyst activity. In fact, if the initial K content is 5 wt % K, the activity would—on a 10% (relative) leaching—increase, since a catalyst with 4.5 wt % K has higher activity than a catalyst with 5 wt % K. This feature compounded with the provision of a higher pore volume in accordance with the present invention, results in a surprisingly robust water gas shift catalyst with significant mechanical strength and no substantial, if any, loss of catalytic activity.

1. Water gas shift catalyst comprising Zn, Al, optionally Cu, and an alkali metal or alkali metal compound, wherein the water gas shift catalyst is a Zn/Al-based catalyst comprising in its active form a mixture of zinc aluminum spinel and optionally zinc oxide in combination with an alkali metal compound selected from K, Rb, Cs, Na, Li and mixtures thereof, in which the Zn/Al molar ratio is in the range 0.3-1.5 and the content of alkali metal is in the range 1-6 wt % based on the weight of oxidized catalyst, and wherein the water gas shift catalyst has a pore volume, as determined by mercury intrusion, of 240 ml/kg or higher.

2. The water gas shift catalyst according to claim 1, having a pore volume, as determined by mercury intrusion, of 240-380 ml/kg.

3. The water gas shift catalyst according to claim 1, comprising only Zn, Al, optionally Cu, and an alkali metal or alkali metal compound.

4. The water gas shift catalyst of claim 1, wherein the Zn/Al molar ratio is in the range 0.5-1.0.

5. The water gas shift catalyst of claim 1, wherein the content of Cu is in the range 0.1-10 wt % based on the weight of oxidized catalyst.

6. The water gas shift catalyst of claim 1, wherein the catalyst is in the form of a pellets, extrudate, or tablet, and wherein the density is 1.2-1.9 g/cm3, as measured by dividing the weight of the catalyst by its geometrical volume

7. The water gas shift catalyst of claim 1, wherein the catalyst is in the form of pellets, extrudates or tablets, and wherein the mechanical strength is in the range ACS: 30-750 kp/cm2, or SCS: 4-100 kp/cm, wherein ACS and SCS are measured in the oxidized form of the catalyst, and according to ASTM D4179-11

8. Process for enriching a synthesis gas in hydrogen by contacting said synthesis gas in a water gas shift reactor with a water gas shift catalyst according to claim 1.

9. The process of claim 8, wherein the water gas shift reactor is a high temperature shift (HTS) reactor.

10. The process of claim 8, wherein the water gas shift reactor is a HTS reactor operating at a temperature in the range of 300-550° C., and optionally also at a pressure in the range 2.0-6.5 MPa.
